(19) United States
(12) Patent Application Publication
(10) Pub. No.: US 2024/0114002 A1
(43) Pub. Date: Apr. 4, 2024

(54) FIREWALL PANIC BUTTON FOR QUARANTINING OPERATIONAL TECHNOLOGY (OT) SYSTEMS FROM REAL-TIME ATTACKS ON INTERNET INFORMATION TECHNOLOGY (IT) SYSTEMS

(71) Applicant: Fortinet, Inc., Sunnyvale, CA (US)

(72) Inventor: Gerardo Andrés Mendel, Salvador (BR)

(21) Appl. No.: 17/957,666

(22) Filed: Sep. 30, 2022

(51) Int. Cl. H04L 9/40

(52) U.S. Cl. CPC H04L 63/0263; H04L 63/08; H04L 63/1416

(57) ABSTRACT

A panic button is configured and disposed outside a network gateway, managing integrated OT network devices and IT devices, for access by a user. Responsive to physical activation of the panic button, a 2 factor MFA authorizes the action with an authorized user. Upon authorization, the OT network devices are quarantined from the IT network devices to prevent malicious actions.

### FIELD OF THE INVENTION

The invention relates generally to computer networking and computer security, and more specifically, to a firewall panic button to quarantine, preserve or isolate an Operational Technology (OT) network from an Information Technology (IT) network during a real-time malicious attack of an integrated network infrastructure.

### BACKGROUND

The Operational Technology (OT) and IOT (Internet of Things) environments often include legacy devices that were not intended for secure network environments. These headless devices are not able to update software and may not have native networking capabilities. The data path extends from a first switch port to a second switch port, both part of the same enterprise network, or the data path extends across the Internet to remote networks. Unfortunately, the data generated by these devices is particularly vulnerable because it is unencrypted.

Traditionally, OT cyber security was not necessary because OT systems were not connected to the IP networks. As such, they were not exposed to network-based threats. As digital innovation initiatives expanded and Information Technology (IT) and OT networks converged, organizations tended to bolt-on specific point solutions to address specific issues. These approaches to OT security resulted in a complex network where solutions could not share information and provide full visibility.

Often, IT and OT networks are kept separate, duplicating security efforts and eschewing transparency. These IT OT networks cannot track what is happening throughout the attack surface. Typically, OT networks report to the COO and IT networks report to the CIO, resulting in two network security teams each protecting half of the total network. This can make it difficult to identify the boundaries of the attack surface because these disparate teams do not know what is attached to their own network. In addition to being difficult to efficiently manage, OT IT networks contain huge gaps in security.

Therefore, what is needed is a robust technique for a panic button to quarantine, preserve or isolate an OT network from an IT network during a real-time malicious attack of an integrated network infrastructure.

### SUMMARY

These shortcomings are addressed by the present disclosure of methods, computer program products, and systems for providing a panic button to quarantine an OT network from an IT network during a real-time malicious attack of an integrated network infrastructure.

In one embodiment, A panic button is configured and disposed outside a network gateway, managing integrated OT network devices and IT devices, for access by a user. Responsive to physical activation of the panic button, a 2 factor MFA authorizes the action with an authorized user. Upon authorization, in one case, the OT network devices are quarantined from the IT network devices to prevent malicious actions. In another case, a set of automated, preconfigured actions are taken to disconnect specific zones, isolate and quarantine critical devices, and log or notify personnel.

Advantageously, OT network devices can be quickly isolated with the press of a button.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level illustration of a system for a panic button to quarantine an OT network from an IT network during a real-time malicious attack of an integrated network infrastructure, according to an embodiment.

FIG. 2 is a more detailed illustration of a network gateway of the system of FIG. 1, according to an embodiment.

FIG. 3 is a high-level flow diagram illustrating a method for a panic button to quarantine an OT network from an IT network during a real-time malicious attack of an integrated network infrastructure, according to one preferred embodiment.

FIG. 4 is a more detailed flow diagram illustrating the step of physically activating panic button, for the method of FIG. 4, according to one embodiment.

FIG. 5 is an example of a computing environment for implementing components of the system of FIG. 1, according to an embodiment.

### DETAILED DESCRIPTION

The description below provides methods, computer program products, and systems for providing a panic button to quarantine an OT network from an IT network during a real-time malicious attack of an integrated network infrastructure.

One of ordinary skill in the art will recognize many additional variations made possible by the succinct description of techniques below.

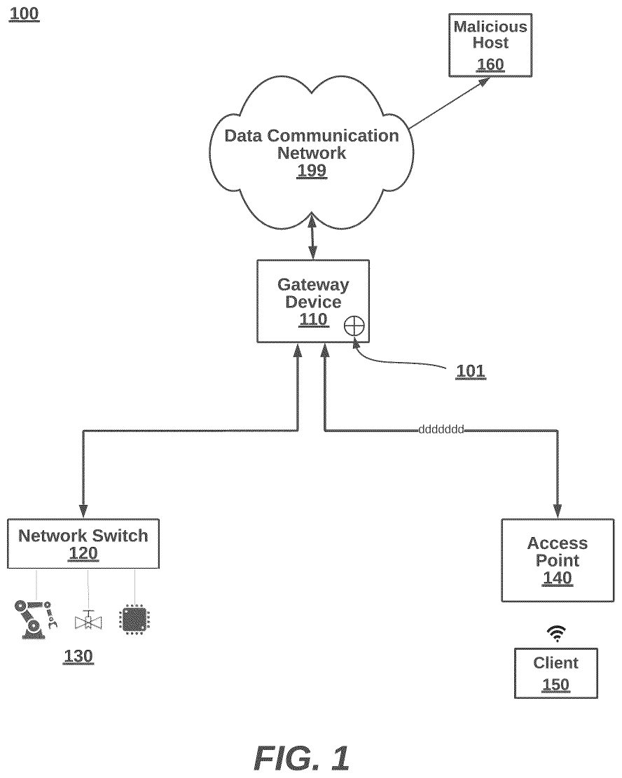

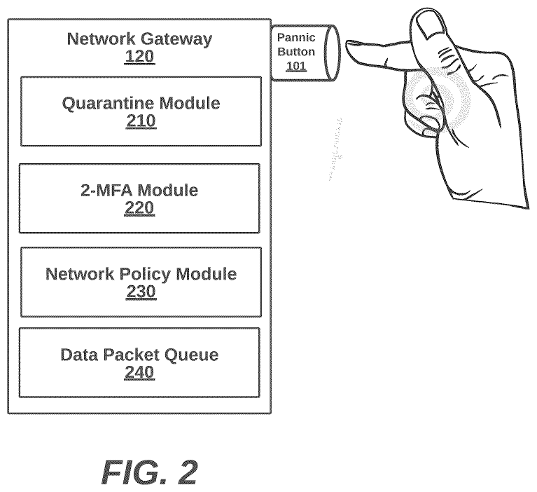

I. Systems for OT Quarantine Panic Button (FIGS. 1-2)

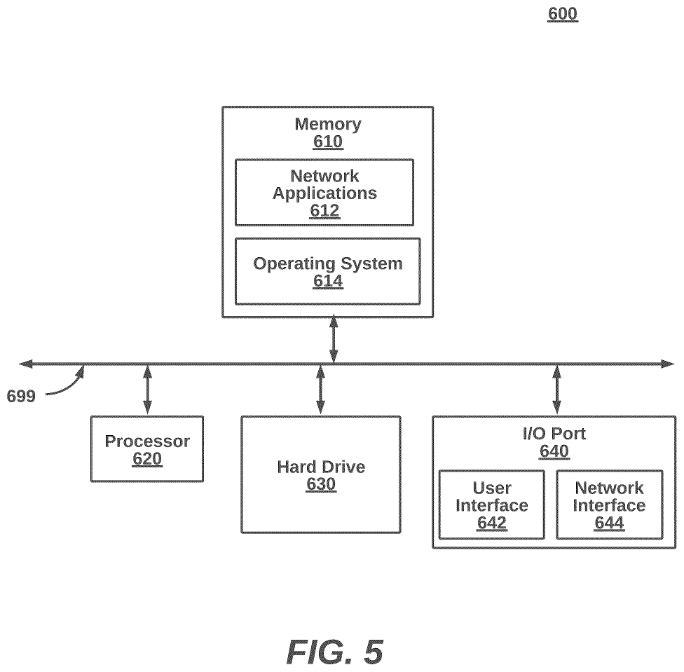

FIG. 1 is a high-level illustration of a system 100 for a panic button to quarantine an OT network from an IT network during a real-time malicious attack of an integrated network infrastructure, according to an embodiment. The system 100 includes network gateway 110 (or firewall) with panic button 101, network switch 120, OT devices 130, access point 140, client 150 and malicious host 160. Many other embodiments are possible, for example, more or fewer access points, more or fewer stations, and additional components, such as firewalls, routers and switches. The system 100 components can be located locally on a LAN or include remote cloud-based devices, and can be implemented in hardware, software, or a combination similar to the example of FIG. 5.

The components of the system 100 are coupled in communication over a data communication network 199. Preferably, network gateway 110 are connected to the data communication system via hard wire. Other components, such as the headless IoT devices can be connected indirectly via wireless connection. The Internet 199 can be any data communication network such as a WAN, a LAN, WLAN, a cellular network (e.g., 3G, 4G, 5G or 6G), or a hybrid of different types of networks. Various data protocols can dictate format for the data packets.

The quarantine panic button 101, in an embodiment, is attached to an outer case of the network gateway device 110. A depression sensor can activate electrical signals that are routed inside the network gateway 110 to an input/output interface. In another embodiment, the quarantine panic button 101 connects via USB, Bluetooth, RCA jack or some other mechanism. The quarantine panic button 101 is accessible for physical activation by a user. Upon user activation, the network gateway 110 performs specific actions for protection from malicious activity. In another embodiment, verification is required, for example, via 2-way MFA from an authorized user. As a result, although a user without network administrative knowledge can initiate the quarantine process, an authorized user with network administrative knowledge must agree. Various other actions can take place besides quarantine, such as deployment of anti-malware, sending notification via e-mail, and the like. Further, some actions may be taken immediately upon activation while other, more serious actions, await verification.

The network gateway 110 can be a firewall that protects the OT network and the IT network from malicious traffic in addition to applying other network policies.

In one embodiment, OT devices 130 are headless devices relying upon the network switch 120 for network intelligence and a master controller for operational instructions. OT, generally, is the use of hardware and software to monitor and control physical processes, devices, and infrastructure. OT systems are found across a large range of asset-intensive sectors, performing a wide variety of tasks ranging from monitoring critical infrastructure to controlling robots on a manufacturing floor. OT is used in a variety of industries including manufacturing, oil and gas, electrical generation and distribution, aviation, maritime, rail, and utilities.

FIG. 2 is a more detailed illustration of the network gateway 120 of the system 100 of FIG. 1. The network gateway 110 includes the panic button 101, a quarantine module 210, a 2-MFA module 220, a network policy module 230 and data packet queue 240. The modules can be implemented in source code stored in non-transitory memory executed by a processor. Alternatively, the modules can be implemented in hardware with microcode. The modules can be singular or representative of functionality spread over multiple components. Many other variations are possible.

The quarantine module 210 detects physical activation of the panic button 101 by a user. In response to activation, the 2-factor module 220 performs 2-Factor MFA for authorization to confirm physical actuation by the authorized user. Responsive to successful MFA authorization, the quarantine module 220 performs a set of security actions to protect the OT network from a real-time attack by malicious traffic on the IT network, including a temporary disconnection of access from the IT network while allowing the IT network to address malicious traffic independently.

The network policy module 230 retrieves and applies a network policy related to the panic button 101 being depressed. The data packet queue 240 stores incoming and outgoing packets for inspection. During quarantine, data packets related to OT devices can be temporarily stored or deleted.

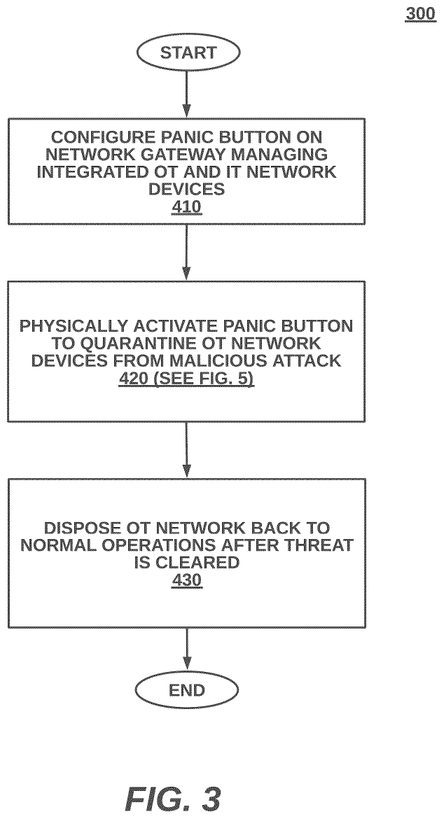

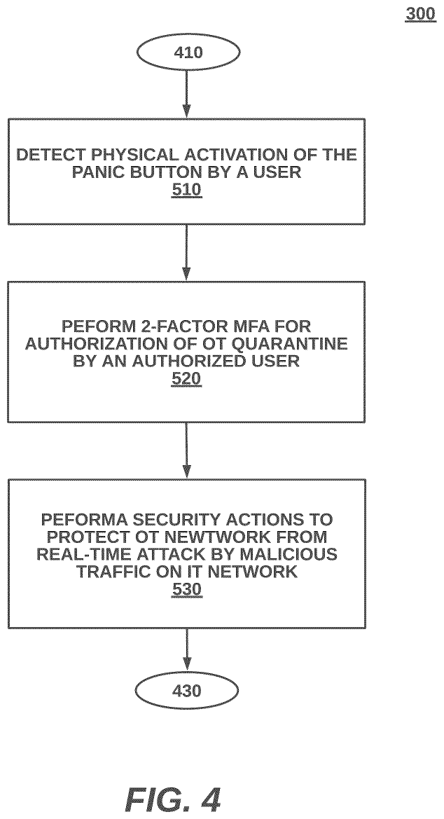

II. Methods for an OT Quarantine Panic Button (FIGS. 3-4)

FIG. 3 is a high-level flow diagram illustrating a method for providing a panic button to quarantine an OT network from an IT network during a real-time malicious attack of an integrated network infrastructure, according to one embodiment. The method 300 can be implemented, for example, by the system 100 of FIG. 1. The steps are merely representative groupings of functionality, as there can be more or fewer steps, and the steps can be performed in different orders. Many other variations of the method 300 are possible.

At step 310, configure panic button on network gateway managing integrated OT and IT network devices. At step 320, a quarantine panic button is physically activated to protect OT network devices, as discussed in more detail with respect to FIG. 4. At step 330, once threat is cleared, the OT network is disposed back to normal operations.

Turning to FIG. 4, the step 420 of OT quarantine is set forth. At step 410, the quarantine module can detect physical activation of the panic button by a user. In response, the 2-factor module performs 2-factor MFA for authorization to confirm physical actuation by the authorized user, at step 420. Responsive to successful MFA authorization, the quarantine module performs a set of security actions to protect the OT network from a real-time attack by malicious traffic on the IT network, at step 430.

III. Generic Computing Device (FIG. 5)

FIG. 5 is a block diagram illustrating an example computing device 500 for use in the system 100 of FIG. 1, according to one embodiment. The computing device 500 is implementable for each of the components of the system 100. The computing device 500 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 500, of the present embodiment, includes a memory 510, a processor 520, a storage drive 530, and an I/O port 540. Each of the components is coupled for electronic communication via a bus 599. Communication can be digital and/or analog and use any suitable protocol.

The memory 510 further comprises network applications 612 and an operating system 514. The network applications 512 can include a web browser, a mobile application, an application that uses networking, a remote application executing locally, a network protocol application, a network management application, a network routing application, or the like.

The operating system 514 can be one of the Microsoft Windows® family of operating systems (e.g., Windows 96, 98, Me, Windows NT, Windows 2000, Windows XP, Windows XP x64 Edition, Windows Vista, Windows CE, Windows Mobile, Windows 6 or Windows 8), Linux, HP-UX, UNIX, Sun OS, Solaris, Mac OS X, Alpha OS, AIX, IRIX32, IRIX64, or Android. Other operating systems may be used. Microsoft Windows is a trademark of Microsoft Corporation.

The processor 520 can be a network processor (e.g., optimized for IEEE 802.11, IEEE 802.11AC or IEEE 802.11AX), a general-purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 520 can be single core, multiple core, or include more than one processing elements. The processor 520 can be disposed on silicon or any other suitable material. The processor 620 can receive and execute instructions and data stored in the memory 510 or the storage drive 530.

The storage drive 530 can be any non-volatile type of storage such as a magnetic disc, EEPROM (electronically erasable programmable read-only memory), Flash, or the like. The storage drive 630 stores code and data for applications.

The I/O port 640 further comprises a user interface 642 and a network interface 544. The user interface 542 can output to a display device and receive input from, for example, a keyboard. The network interface 544 (e.g., an RF antennae) connects to a medium such as Ethernet or Wi-Fi for data input and output. Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems). Some embodiments can be implemented with artificial intelligence.

Furthermore, the computer that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer ⅔ routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

I claim:

1. A firewall network gateway device with a panic button to quarantine an OT network from an IT network during a real-time malicious attack of an integrated network infrastructure, the firewall network gateway device comprising:
a processor;
a network interface communicatively coupled to the processor and communicatively coupled to the IT network and the OT networks, wherein the OT network includes one or more headless endpoint devices; and
a memory, comprising a quarantine module and a 2 factor module and communicatively coupled to the processor;
a quarantine panic button, accessible for physical activation by a user and communicatively coupled to the processor, to perform specific actions upon physical activation by any user, including MFA credentials associated with an authorized user;
wherein the quarantine module detects physical activation of the panic button by a user, and in response, the 2 factor module performs 2 factor MFA for authorization to confirm physical actuation by the authorized user, and responsive to successful MFA authorization, the quarantine module performs a set of security actions to protect the OT network from a real-time attack by malicious traffic on the IT network, including a temporary disconnection of access from the IT network while allowing the IT network to address malicious traffic independently.

2. A method in a network gateway, implemented at least partially in hardware, for a panic button to quarantine an OT network from an IT network during a real-time malicious attack of an integrated network infrastructure, the method comprising the steps of:
configuring the panic button for physical access on the network gateway;
detecting physical activation of the panic button by a user;
responsive to detecting physical activation of the panic button, performing 2 factor module performs 2 factor MFA for authorization of security actions by an authorized user;
responsive to successful MFA authorization, performing a set of security actions to protect the OT network from a real-time attack by malicious traffic on the IT network.

3. The method of claim 2, wherein the security actions comprise at least one of isolating critical components isolating a zone.

4. A non-transitory computer-readable media in a network gateway, implemented at least partially in hardware, when executed by a processor, for a panic button to quarantine an OT network from an IT network during a real-time malicious attack of an integrated network infrastructure, the method comprising the steps of:
configuring the panic button for physical access on the network gateway;
detecting physical activation of the panic button by a user;
responsive to detecting physical activation of the panic button, performing 2 factor module performs 2 factor MFA for authorization of security actions by an authorized user;
responsive to successful MFA authorization, performing a set of security actions to protect the OT network from a real-time attack by malicious traffic on the IT network.
